(19) United States
(12) Patent Application Publication
(10) Pub. No.: US 2008/0156166 A1
(43) Pub. Date: Jul. 3, 2008

(54) Cutting Device

(75) Inventors: Kerstin Ihlow, Holle (DE); Jorg Peter, Holle (DE)

Correspondence Address: SYNNESTVEDT & LECHNER, LLP, 1101 MARKET STREET, SUITE 2600, PHILADELPHIA, PA, 19107-2950, US

(73) Assignee: IHLOW STANZ-UND KUNSTSTOFFTECHNIK GMBH, Holle (DE)

(21) Appl. No.: 11/916,050

(22) PCT Filed: Apr. 20, 2006
(86) PCT No.: PCT/EP06/03599

§ 371 Date: Nov. 30, 2007

(30) Foreign Application Priority Data
Jun. 17, 2005 (DE) 20 2005 009 548.6

(51) Int. Cl. B26D 1/00

(52) U.S. Cl. 83/856

(57) ABSTRACT

The invention relates to a cutting device provided with a simple design, easiness of use and with improved cleanability. This cutting device serves to cut foodstuffs into slices and strips. To this end, the device is provided with a fixed blade element, which has a cutting edge (13) and which, together with an elastically deflectable flexible tongue (9), forms an adjustable cutting gap for the item to be cut. A slideway for the item to be cut is formed by the flexible tongue (9). A shaft supporting a blade arrangement (27) extends transversal to the slideway and is equipped with disk cutters, which extend perpendicular to the axis of the shaft and which are guided though slots of the flexible tongue (9). The disk cutters project into the slideway to an extent the defines the height of cut that can be set according to the rotation angle position of said shaft. The flexible tongue (9) is mounted on a frame, which can be displaced in the advancing direction of the item to be cut and whose displacement enables the height of a cutting gap to be changed. A shaft (16) extending parallel to the aforementioned shaft is provided that is drive-connected to the frame with regard to the displacement thereof. The cutting gap height and height of cut can be set easily and independent of one another.

The invention relates to a cutting device according to the preamble of claim 1.

A cutting device of this type is known from DE-GM-203 18 619. This cutting device consists of a plate-like basic element forming on its upper side a slideway for the item to be cut, a portion of this slideway being configured as a flexible tongue which can be resiliently deflected out of the plane thereof and the free end of which forms a cutting gap with a fixed blade element. A shaft fitted with disk cutters extends transversely to the slideway, below the flexible tongue, the disk cutters extending through slots in the flexible tongue and protruding on the upper side from the slideway. The shaft carries a plurality of arrangements of disk cutters which differ in terms of the closeness of their axial staggering, so rotating this shaft allows differing blade arrangements to be brought to bear in the slideway and therefore items to be cut with differing strip width. Located below the basic element is a frame which is arranged so as to be displaceable in the longitudinal direction of the device and consists of two elongate guide profiles on which the flexible tongue rests with resilient pre-stress. The guide profiles have on their underside ramp-like guide portions via which they rest on the aforementioned shaft, whereas their upper sides, each extending parallel to the base plane of the flexible tongue, form the rest for the flexible tongue. The frame is drive-connected to a spindle gear which is actively connected to an adjusting knob which is mounted in the handle, is rotatable about an axis extending in the longitudinal direction of the device and facilitates displacement of the frame and, in conjunction with the ramp-like guide portions, resilient deflection of the flexible tongue perpendicularly to the base plane thereof. The flexible tongue, and thus the effective height of the cutting gap, can therefore be adjusted independently of the setting of a specific blade arrangement or a width of cut.

In accordance with the setting of the blade arrangement and of the cutting gap, this known cutting device allows an item of adjustable thickness to be cut into slices or strips. However, the use of a spindle drive for setting the cutting gap, but also the accommodation of an adjusting knob within the handle, results in a comparatively complex construction. In individual cases, this complex construction can also entail hygiene problems, as cleaning the construction is comparatively complex.

Against this background, the object of the invention is to configure a cutting device of the type described at the outset with regard to a simpler design and improved ease of use, especially with regard to cleanability. In the case of a cutting device of this type, this object is achieved by the features of the characterizing part of claim 1.

It is accordingly fundamental to the invention that the frame intended for deflection of the flexible tongue be drive-connected to a shaft of this type extending parallel to the shaft carrying the blade arrangement. This arrangement allows much improved accessibility compared to the prior art described at the outset and improved and simplified cleanability associated therewith. It also allows a simpler design of a drive connection between the rotational movement of the shaft and the movement of displacement of the frame.

The features of claims 2 and 3 relate to differing configurations of the frame guide, both of which aim to exert a deflection movement on the flexible tongue, perpendicularly to the base plane thereof. Ramp-like guide faces, on which the frame is arranged so as to be able to slide, may thus be provided in the region of the guide elements of the side walls, be constructionally integrated therein or be provided in the region of the contact faces between the frame and the guide profiles. However, ramp-like guide faces can also be provided both in the region of the aforementioned guide elements and in the region of the aforementioned contact faces—in this case, aiding one another in their deflection effect. In any case, the flexible tongue should rest against these guide or contact faces with resilient prestress and, in addition, the respective angle of inclination should be applied in a self-locking manner. Other methods for fixing a displacement position, once set, of the frame, such as, for example, influencing the friction conditions in the region of the guide faces by appropriate selection of the material pairings, surface structuring of these faces, etc., are also possible.

In accordance with the features of claim 4, the aforementioned guide faces are arranged in the region of the free end of the flexible tongue, symmetrically to a vertical longitudinal center plane of the flexible tongue. This ensures uniform exertion of force on the flexible tongue, in particular in the region of the cutting gap. This provides precise cutting gap geometry over the entire adjustment range.

A cross strut or the like in the sense of the features of claim 5 exerts a mechanically stabilizing effect on the form of the cutting gap, over the entire adjustment range of the height of the cutting gap. This is advantageous for a uniform, reproducible cutting result.

In accordance with the features of claim 6, the blade element is oriented in a manner known per se at an angle to the direction of advancement for the item. In this case, in particular, a symmetrical arrangement of the guide faces for the frame is very important, as this also ensures precise cutting gap geometry.

A drive connection between the frame and the shaft mentioned at the outset can be brought about in an especially simple manner, in accordance with the features of claim 7, via a single entrainment element which is rotationally engaged with the aforementioned shaft and is configured, for example, as a lever, cam or the like. This entrainment element is connected in an interlocking manner to a single recess in the frame, which interlocking connection is applied to convert a rotational movement of the entrainment element into a movement of advancement of the frame.

The fact that, in accordance with the features of claim 8, the adjusting knobs for setting the height of the cutting gap, on the one hand, and the blade arrangement, on the other hand, are arranged on opposing sides of the cutting device allows convenient actuation thereof.

As can be seen from the above, the cutting device according to the invention provides a device which is simple to handle and can be used advantageously, especially in kitchens. The individual components of the device can advantageously be assembled and disassembled for cleaning purposes without requiring a specific tool.

The invention will be described hereinafter in greater detail with reference to the embodiment of a cutting device illustrated schematically in the drawings, in which:

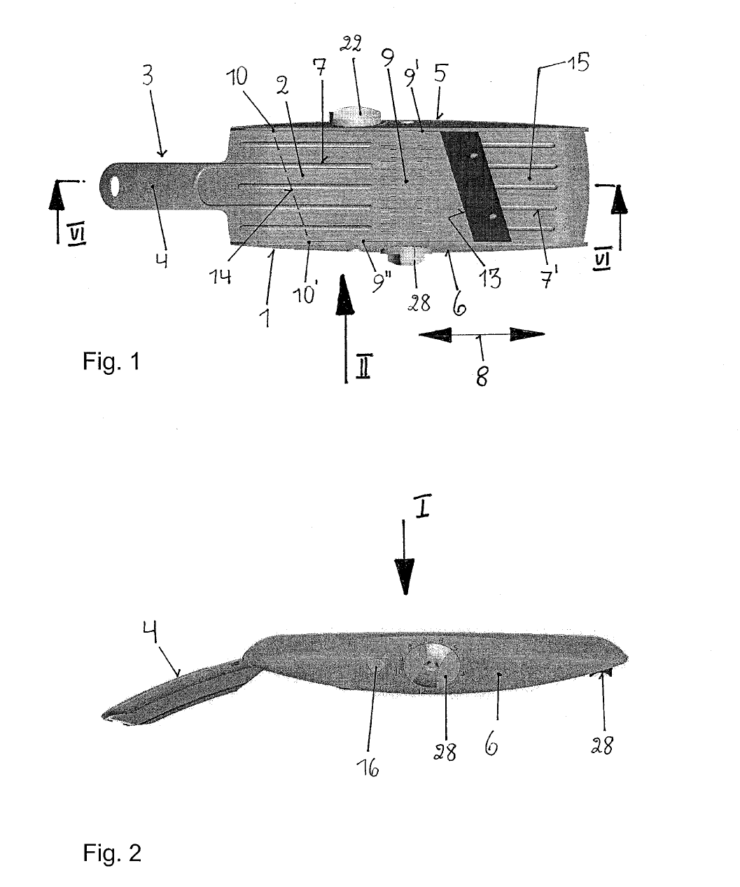

FIG. 1 is a plan view, in the direction indicated by arrow I in FIG. 2, of an embodiment of a cutting device according to the invention;

FIG. 2 is a side view, in the direction indicated by arrow II in FIG. 1, of the cutting device;

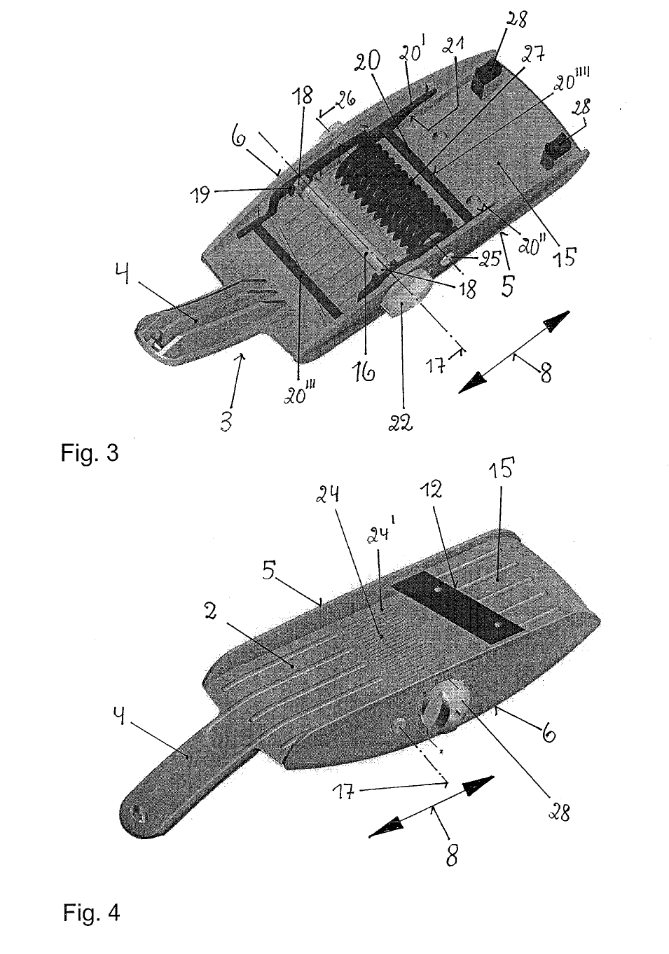

FIG. 3 is a perspective view from below of the cutting device shown in FIG. 1;

FIG. 4 is a perspective view from the right-hand side of the cutting device shown in FIG. 1;

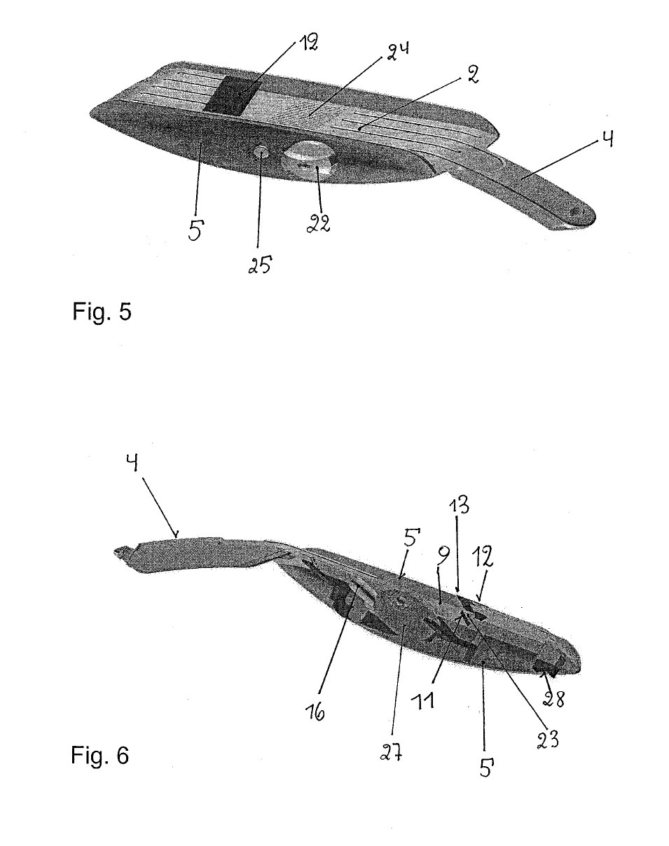

FIG. 5 is a perspective view from the left-hand side of the cutting device shown in FIG. 1; and

FIG. 6 is a perspective cross section, taken along plane VI-VI in FIG. 1, of the cutting device.

In FIG. 1, reference numeral 1 denotes the plate-like basic element of the cutting device according to the invention that forms on its upper side a slideway 2 for the item to be cut and with the left end 3 of which, as shown in the drawing, a handle 4 is integrally formed.

As FIG. 2, in particular, shows, the handle 4 extends at an acute angle to the base plane of the slideway 2.

Reference numerals 5, 6 denote side walls which extend perpendicularly to and laterally surround the slideway 2. These side walls 5, 6 exert, together with strip-like surface profiles 7 of the slideway 2, a guiding force on the item to be treated during its movement of advancement parallel to the directions indicated by the arrow 8.

On the underside of the cutting device too, the side walls 5, 6 protrude beyond the plane of the slideway 2, as FIG. 3, for example, shows.

At its left end, as shown in FIG. 1, the slideway 2 comprises a flexible tongue 9 which can be deflected perpendicularly to the plane of said slideway, so a respective gap 9′, 9″ is located between said flexible tongue and the side walls 5, 6. These gaps 9′, 9″ each end at their left ends, as shown in FIG. 1, at the points 10, 10′, the right free end 11 of the flexible tongue 9 being located below a fixed blade element 12, the cutting edge 13 of which extends at an angle to the arrows 8, in particular parallel to a connecting line 14 between the points 10, 10′ defining the ends of the gaps 9′, 9″. Along this connecting line 14, the flexible tongue 9 is therefore rigidly connected to the basic element 1.

The cutting edge 13 delimits, in conjunction with the flexible tongue 9 and the side walls 5, 6, a cutting gap 23 extending in a plane perpendicular to the base plane of the flexible tongue 9 and, in accordance with the above-described arrangement of the cutting edge 13, at an angle to the arrows 8.

The blade element 12, which is preferably exchangeably arranged, is fastened to the free end of a base portion 15 which connects the side walls 5, 6, extends substantially parallel to the base plane of the slideway 2 and carries on its upper side, in turn, profiles 7′ suitable for exerting a guiding force on the item to be treated. This base portion 15 forms the continuation of the slideway 2 and is separated therefrom by the cutting gap 23 forming a step.

Both the left end of the slideway 2 and the right end of the base portion 15 are curved toward the underside of the cutting device.

Reference numeral 16 denotes a shaft, the underside of which is mounted, with regard to the flexible tongue 9, in a region, adjacent to the connecting line 14, in the side walls 5, 6 and the axis 17 of which extends perpendicularly to the side walls 5, 6. At its ends facing the side walls 5, 6, the shaft 16 is respectively rotationally engaged with entrainment elements 18 which are, in turn, engaged in an interlocking manner with receptacles 19 of a frame 20. The interlocking fit is applied in such a way that rotation of the shaft 16 allows a force to be exerted on the frame 20 in the direction indicated by the arrow 8.

The frame 20 consists substantially of two guide profiles 20′, 20″ which extend along the inside of the side walls 5, 6 and are joined together in the region of their leading and trailing ends, with regard to the cutting device, via cross struts 20′″, 20″″.

The end of the frame 20 that faces the base portion 15, in particular the two guide profiles 20′, 20″ thereof, rest(s) against ramp-like guide faces 21 formed on the underside of the base portion 15. At the same time, in the region of the cross strut 20, they rest against the underside of the flexible tongue 9. As may be seen, rotation of the shaft 16 allows the frame 20 to be displaced, via the interlocking engagement of the entrainment elements 18 in the receptacles 19, in the direction indicated by the arrow 8, the abutment against the ramp-like guide faces 21 causing corresponding deflection of the flexible tongue 9 perpendicularly to the base plane thereof.

The frame 20 can be displaced in the direction indicated by the arrow 8 with collaboration of a plurality of guide elements formed integrally with the inside of the side walls 5, 6. In all deflection positions, the flexible tongue 9 rests against the aforementioned guide profiles of the frame 20 with resilient prestress.

Reference numeral 22 denotes an adjusting knob which is rotationally engaged with the shaft 16 and via which deflection of the flexible tongue 9 can be brought about. As may be seen, in particular, from the illustration according to FIG. 6, raising and lowering the flexible tongue 9 allows the height of the cutting gap 23 extending between the blade element 12 and the free end 11 of the flexible tongue 9 to be continuously adjusted.

Reference numeral 24 denotes a portion which—viewed in the longitudinal direction of the flexible tongue 9—is located between the axis 17 and the blade element 12 and is characterized by an arrangement of slots extending parallel to one another in the longitudinal direction of the flexible tongue 9, this slot arrangement filling the width of the flexible tongue—viewed perpendicularly to the arrows 8—almost completely.

Below this portion 24 there extends a shaft 25, the axis 26 of which extends parallel to the axis 17. The shaft 25 is mounted in the side walls 5, 6 of the cutting device and carries a blade arrangement 27, the individual disk cutters of which extend perpendicularly to the axis 26 and are set apart from one another so as to project through the individual slots 24′ in the portion 24 and into the plane of the slideway 2.

Each disk cutter of the blade arrangement 27 has—viewed in the radial direction with regard to the axis 26—dimensions which vary in the circumferential direction so, in accordance with the rotation of the shaft 25, the disk cutters protrude on the upper side to a greater or lesser extent from the slots of the slot arrangement 24′.

The above-described composition of the blade arrangement 27 is intended merely as an example. The disk cutters can also be provided on the shaft 25 in such a way that rotation about the axis 26 causes either all disk cutters, merely every other disk cutter, every third disk cutter, etc. to issue on the upper side from the slot arrangement of the portion 24. In this case, there are provided on the shaft 25 a plurality of disk cutter arrangements which can optionally be used and which differ from one another in terms of the closeness of the axial staggering of the disk cutters. It is thus possible to cut an item into strips in accordance with differing widths of cut. Both the width of cut and the height of cut of the blade arrangement 27 can therefore be adjusted by rotating the shaft 25.

Reference numeral 28 denotes, in turn, an adjusting knob which is rotationally engaged with the shaft 25 and is used for adjusting the blade arrangement 27. Reference numeral 28 denotes two holding blocks which protrude on their underside from the space laterally delimited by the side walls 5, 6 and are arranged at the end of the cutting device that is remote from the handle 4. Both holding blocks 28 are of identical composition and provided with an overall U-shaped recess which is open toward the underside, the recesses in both holding blocks 28 being mutually aligned. The purpose of these holding blocks 28 is to allow the cutting device to be held in a simple manner in a position located on the edges of a container.

To use the cutting device, the device is fixed to the edges of a container using the holding blocks 28, once the height of the cutting gap and the blade arrangement have each been appropriately set using the adjusting knobs 22, 28. The item to be cut is then guided via the slideway 2, moving back and forth in the direction of advancement 8, using a scraps holder known per se, the engagement with the disk cutters of the blade arrangement 27 and of the blade element 12 in the region of the cutting gap 23 leading to the formation of a cut item which has a defined strip width and strip height and is collected in the aforementioned container after passing through the cutting gap 23.

The cutting device is distinguished by an especially simple construction. The frame 20 and the aforementioned shafts 16, 25 can, in particular, be assembled and disassembled again especially easily for the purposes of cleaning without the need for a specific tool.

The cutting device therefore provides a device which is convenient to handle and is suitable for numerous food cutting processes, especially in kitchens. Apart from the blade element 12 and the blade assembly 27, which are preferably metallic parts, all remaining components can be made of a plastics materials.

1. A cutting device for the cutting of foods into slices and strips, comprising a resiliently deflectable flexible tongue (9) which delimits with a cutting edge (13) of a fixed blade element (12) a cutting gap (23) which is adjustable with regard to the thickness of the item to be cut, which tongue at the same time forms a slideway (2) for the item, comprising a shaft (25) which is mounted so as to be rotatable about an axis (26) extending transversely to the slideway (2) of the item and carries a blade arrangement (27), the blade arrangement (27) consisting of at least one arrangement of disk cutters which extend perpendicularly to the axis (26), are guided through slots (24) in the flexible tongue (9) and project on their upper side from said tongue into the slideway (2) to an extent that defines the height of cut, wherein at least the height of cut can be set according to the rotation angle position of the shaft (25), the flexible tongue (9) being mounted on a frame (20) which can be displaced substantially in a direction of advancement (8) of the item and in the opposite direction in such a way that the movement of displacement of said frame can be converted into a deflection, changing the height of the cutting gap (23), of the flexible tongue (6), substantially perpendicularly to the base plane thereof, and wherein the height of cut of the disk cutters and the height of the cutting gap (23) can be set independently of each other, characterized by a shaft (16) which extends parallel to the axis (26) and is drive-connected to the frame (20) with regard to the aforementioned movement of displacement thereof.

2. The cutting device as claimed in claim 1, characterized in that the frame (20) consists of two interconnected guide profiles (20′, 20″) which extend parallel to each other and are arranged in internally arranged guide elements of side walls (5, 6), so as to be displaceable in the longitudinal direction thereof, in that the guide profiles (20′, 20″) rest against the flexible tongue (9) so as to be able to slide locally, in a manner suitable for exerting a force perpendicularly to a contact face, and in that the guide elements have ramp-like guide faces (21) which cooperate with opposing faces of the frame (20), so displacement of the frame (20) in accordance with the aforementioned guide faces (21) can bring about deflection of the flexible tongue (9) perpendicularly to the base plane thereof.

3. The cutting device as claimed in claim 1, characterized in that the frame (20) consists of two interconnected guide profiles (20′, 20″) which extend parallel to each other and are arranged in internally arranged guide elements of side walls (5, 6), so as to be displaceable in the longitudinal direction thereof, in that ramp-like guide faces are positioned between the guide profiles (20′, 20″) and the flexible tongue (9), in that the guide profiles (20′, 20″) are received in the aforementioned guide elements of the side walls so as to be displaceable substantially parallel to the direction of advancement for the item, so displacement of the frame (20) in accordance with the aforementioned guide faces can bring about deflection of the flexible tongue (9) perpendicularly to the base plane thereof.

4. The cutting device as claimed in claim 1, characterized in that the aforementioned guide faces (21) are arranged adjacently to the free end of the flexible tongue (9), symmetrically either side of a vertical longitudinal center plane of the flexible tongue (9).

5. The cutting device as claimed in claim 1, characterized in that the frame (20) is provided in the region of the free end of the flexible tongue (9) with a cross strut (20″″) which supports said flexible tongue and connects the guide profiles (20′, 20″).

6. The cutting device as claimed in claim 1, characterized in that the blade element (12) extends at an angle to the direction of advancement (8) for the item.

7. The cutting device as claimed in claim 1, characterized in that at least one entrainment element (18), which engages with a recess in the frame (20), is rotationally engaged with the shaft (25).

8. The cutting device as claimed in claim 1, characterized in that an adjusting knob (28), which is intended for adjusting the blade arrangement (27) and is arranged on the shaft (25), and an adjusting knob (22), which is intended for adjusting the height of the cutting gap (23) and is arranged on the shaft (16), are arranged on the respective outsides of the opposing side walls (5, 6).

9. The cutting device as claimed in claim 2, wherein the aforementioned guide faces (21) are arranged adjacently to the free end of the flexible tongue (9), symmetrically either side of a vertical longitudinal center plane of the flexible tongue (9).

10. The cutting device as claimed in claim 3, wherein the aforementioned guide faces (21) are arranged adjacently to the free end of the flexible tongue (9), symmetrically either side of a vertical longitudinal center plane of the flexible tongue (9).

11. The cutting device as claimed in claim 2, wherein the frame (20) is provided in the region of the free end of the flexible tongue (9) with a cross strut (20″″) which supports said flexible tongue and connects the guide profiles (20′, 20″).

12. The cutting device as claimed in claim 3, wherein the frame (20) is provided in the region of the free end of the flexible tongue (9) with a cross strut (20″″) which supports said flexible tongue and connects the guide profiles (20′, 20″).

13. The cutting device as claimed in claim 2, wherein the blade element (12) extends at an angle to the direction of advancement (8) for the item.

14. The cutting device as claimed in claim 3, wherein the blade element (12) extends at an angle to the direction of advancement (8) for the item.

15. The cutting device as claimed in claim 2, wherein at least one entrainment element (18), which engages with a recess in the frame (20), is rotationally engaged with the shaft (25).

16. The cutting device as claimed in claim 3, wherein at least one entrainment element (18), which engages with a recess in the frame (20), is rotationally engaged with the shaft (25).

17. The cutting device as claimed in claim 2, wherein an adjusting knob (28), which is intended for adjusting the blade arrangement (27) and is arranged on the shaft (25), and an adjusting knob (22), which is intended for adjusting the height of the cutting gap (23) and is arranged on the shaft (16), are arranged on the respective outsides of the opposing side walls (5, 6).

18. The cutting device as claimed in claim 3, wherein an adjusting knob (28), which is intended for adjusting the blade arrangement (27) and is arranged on the shaft (25), and an adjusting knob (22), which is intended for adjusting the height of the cutting gap (23) and is arranged on the shaft (16), are arranged on the respective outsides of the opposing side walls (5, 6).

19. The cutting device as claimed in claim 4, wherein the frame (20) is provided in the region of the free end of the flexible tongue (9) with a cross strut (20″″) which supports said flexible tongue and connects the guide profiles (20′, 20″).

20. The cutting device as claimed in claim 4, wherein the blade element (12) extends at an angle to the direction of advancement (8) for the item.
